(19) United States
(12) Patent Application Publication
(10) Pub. No.: US 2002/0050179 A1
(43) Pub. Date: May 2, 2002

(54) Apparatus for simulating a vehicle collision

(76) Inventors: Wolfgang Buescher, Duesseldorf (DE); Christoph Doeppe, Essen (DE)

Correspondence Address: KATHRYN A. MARRA, DELPHI TECHNOLOGIES, INC., Legal Staff, P.O. Box 5052, Mail Code: 480-414-420, Troy, MI, 48007-5052, US

(21) Appl. No.: 09/953,069

(22) Filed: Sep. 14, 2001

(30) Foreign Application Priority Data
Oct. 10, 2000 (DE) 100 50 080.3

(51) Int. Cl. G01N 17/00

(52) U.S. Cl. 73/865.6

(57) ABSTRACT

The invention concerns an apparatus 1 for simulating a vehicle collision which provides a reusable test for simulations. A carrier 2 with linear guide means is provided, so that a carriage 5 is movable relatively as well as translationally to the carrier 2, and that a foot plate 8 is linked to the carriage 5 so as to be rotationally movable about an axis of rotation a.

### TECHNICAL FIELD

The invention concerns an apparatus for simulating a vehicle collision.

1. Background of the Invention

It is basically known that a vehicle collision can be investigated with a crash test using a vehicle cell (body). In this case the vehicle cell is accelerated to the desired speed, in order then to crash against an obstacle in the desired position. In such tests, the test structure (vehicle cell with the sensors positioned for detection of measurement data) is destroyed. In other words, the whole process is irreversible.

2. Summary of the Invention

It is an object of the present invention to provide an apparatus with which a vehicle collision can be simulated reversibly, and in which all movements, speeds and accelerations acting on the driver and in particular on his lower extremities as a result of a crash can easily be simulated.

It is in particular an object of the present invention to provide an apparatus for investigating dynamic leg space intrusions.

This object is achieved according to the invention by the fact that a carrier with linear guide means is provided, so that a carriage is provided that is movable relatively as well as translationally to the carrier, and that a foot plate is linked to the carriage so as to be rotationally movable about an axis of rotation. With the apparatus leg space intrusions, that is, deformations of the vehicle interior on the leg space side, can be carried out by means of dummies easily, and reversibly without having to destroy a vehicle cell each time. The apparatus allows with this arrangement both the simulation of translational deformations of a vehicle dashboard, and the simulation of rotational deformations of a vehicle dashboard on which is located for example a pedal bracket with pedals linked to it.

According to an embodiment of the invention, associated with the foot plate and carriage are pyrotechnic drive means for a relative movement and/or rotation of carriage and/or foot plate. This structure requires low expenditure on apparatus, the degree of acceleration being variable by varying the pyrotechnic drive means.

According to another embodiment of the invention, hydraulic drive means are provided for a relative movement and/or rotation of carriage and/or foot plate. Hydraulic drive means have the merit that stroke length, speed, acceleration and forces are easy to adjust and vary. This is particularly important in relation to adaptation to different vehicle models or collision circumstances.

It is finally provided that there is at least one hydraulic cylinder for driving the foot plate (rotational movement) and at least one hydraulic cylinder for driving the carriage (translational movement).

If each cylinder is assigned hydraulic control means, in particular hydraulic control valves, for controlled displacement of foot plate and carriage with respect to speed of movement, acceleration and/or force, this allows completely independent control of the two assemblies as well as controlled superposition of the rotational and translational movements.

An electrical signal of an activation device clears the hydraulic control means to a certain extent. Depending on this activation signal, synchronised control for the two independent assemblies is ensured. The activation device can be for example a control device for igniting airbag devices.

In a further embodiment of the invention it is an advantage if the hydraulic control means enable a pressureless bypass position of the cylinders. In this case the pressure chambers of the hydraulic cylinders are directly connected to each other pressurelessly or to a pressureless hydraulic reservoir (liquid tank). As a result of this hydraulic short circuit, manual cylinder positioning or return is possible.

If the hydraulic cylinder for driving the foot plate and/or the hydraulic cylinder for driving the carriage exhibits end-position damping, the acceleration and/or deceleration forces generated can easily be reduced. In an advantageous manner, therefore, the forces exerted on the apparatus can be kept low, which increases the fatigue strength.

It is furthermore an advantage if at least one of the hydraulic cylinders is provided with means for varying the stroke length. This opens up many possibilities of adaptation to different configurations.

The field of application can finally be further increased by the fact that the carrier is fixed to a vehicle cell or a carriage simulating the vehicle cell, for example with a reinforced vehicle cell structure. In other words, by this means not only can a leg space intrusion be simulated, but also a deceleration of the vehicle passengers caused by a crash in the sense of a general view.

### BRIEF DESCRIPTION OF THE INVENTION

Further details of the invention are apparent from the description in connection with subsidiary claims and the drawings. The drawings show:

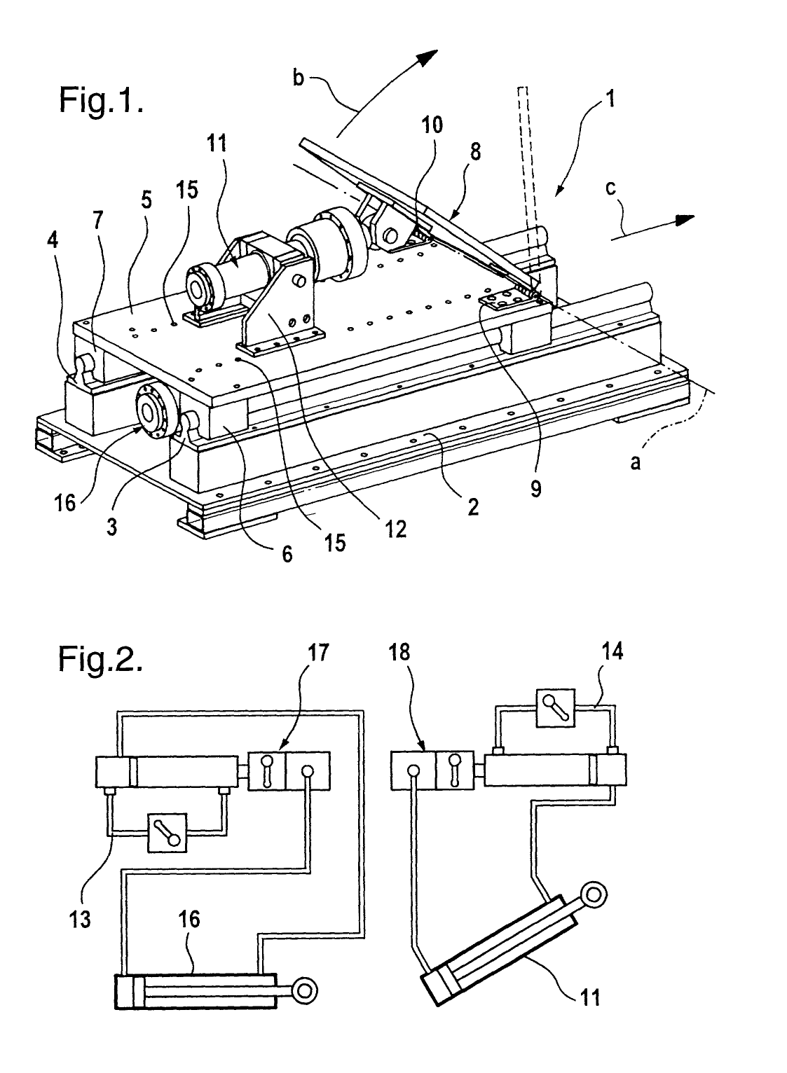

FIG. 1 is an apparatus for simulating a vehicle collision in a perspective view;

FIG. 2 is a highly simplified partial hydraulic circuit diagram for hydraulic cylinders of an apparatus according to FIG. 1;

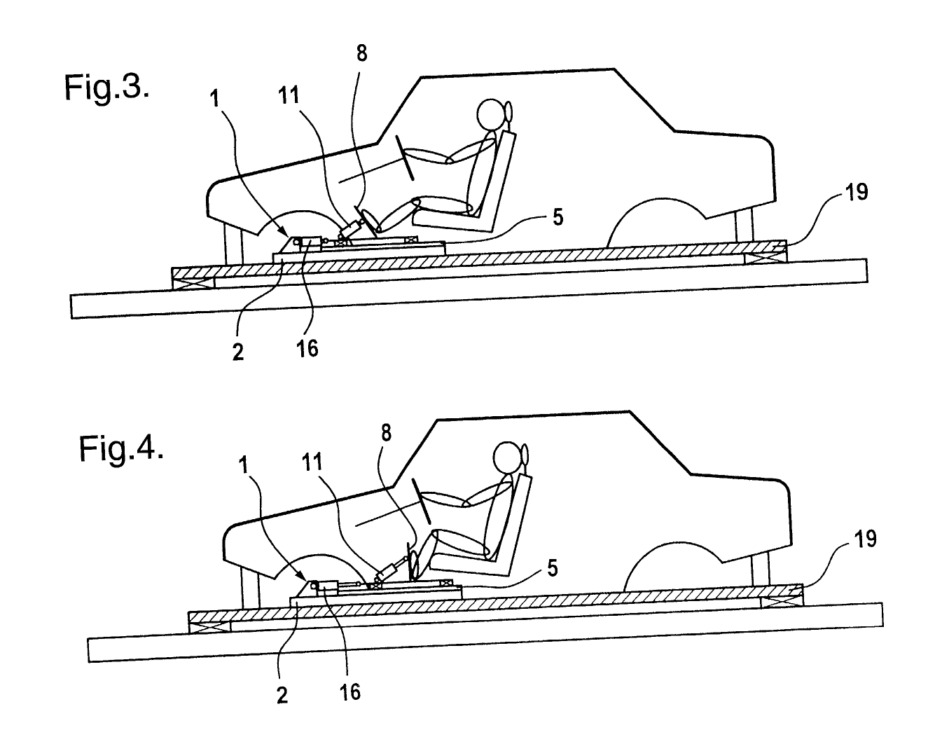

FIG. 3 is a schematised simulation apparatus mounted on a carriage in a starting position, and

FIG. 4 is an arrangement according to FIG. 3 after crash simulation with leg space intrusion.

### DESCRIPTION OF THE PREFERRED EMBODIMENT

As can be seen from FIG. 1, an apparatus 1 for simulating a vehicle collision has a carrier 2. The carrier 2 according to the embodiment is constructed as a flat plate which comprises two parallel rail elements 3, 4 as linear guide means. A carriage 5 is arranged on the rail elements 3, 4 so as to be movable relatively as well as translationally (in the direction of the arrow c) to the carrier 2, and it can be seen that the profiling of the rails 3, 4 and the profiling of rail receiving bodies 6, 7 on the carriage side comprise undercut regions which prevent the carriage 5 from lifting off in a vertical direction. For instance, the profiling is circular and connected by a thin-walled web to a rail body, so that there are at least partially encompassed undercut regions.

The carrier 2 essentially has the form of a flat plate. Further, a foot plate 8 is linked to the carriage 5 rotationally and so as to be movable about an axis of rotation a (in the direction of the arrow b). For this purpose there are provided hinges 9, 10 or joints which are attached by one arm to the foot plate 8 and by another arm to the carriage 5. A pivoted position of the foot plate 8 is shown in broken lines in FIG. 1.

An upper side of the foot plate 8 serves to place the feet of at least one dummy, not shown. This support is therefore directly in keeping with the support of a passenger's foot on a real pedal pad. Preferably a hydraulic drive means in the form of a hydraulic cylinder 11 serves for rotational pivoting of the foot plate 8. Very basically, however, a pyrotechnic drive with an explosive charge is conceivable if a particularly simple structure is important, and if control of movement is of secondary importance. In this case the energy impulse generated can be influenced by variation of the explosive charge.

As can be seen from the drawings, the cylinder 11 for the foot plate 8 is provided on a holding frame 12 which is fixed to the carriage 5. A piston rod protruding from the cylinder 11 is linked by its free end to the foot plate 8. When the piston rod is extended, this leads to a rotational movement of the foot plate 8 about the axis of rotation a. The stroke length of the cylinder 11 can be influenced by a bypass pipe 13 which can be shut off.

When the bypass pipe 13 is open, it makes a direct connection between the two pressure chambers of the hydraulic cylinder 11, which are separated by a piston face, so that the cylinder 11 can be moved manually into a position with a particular extended length of the piston rod. After such an adjustment has taken place, hydraulic operation begins at this point. The result is a reduced residual stroke. If a separate valve assembly for a bypass circuit is integrated in the supply pipes of the cylinders 11, basically the separate bypass pipe 13 can also be dispensed with. Consequently the traditional supply pipes can also be used to make the above-mentioned bypass circuit (hydraulic short circuit).

The undeflected neutral position of the foot plate 8 can be caused by relative displacement of the holding frame 12 in relation to the axis of rotation a. For this purpose the carriage 5 is provided with rows of holes arranged in pairs, which serve to bolt the holding frame 12. Displacement of the holding frame 12 in a direction towards the axis a consequently leads to a steeper position of the foot plate 8. Very generally the stroke length and the undeflected neutral position are adjustable independently of each other. However, the neutral position of the foot plate 8 can also be varied by displacement of the piston rod (see above) if a reduction of the residual stroke is tolerable. The variation of neutral position and stroke length of the two cylinders 11, 16 can generally be influenced in the same way if a hydraulic cylinder 16 is provided for driving the carriage 5 (FIG. 1).

This cylinder is linked by a bracket, not shown, to the carrier 2 and by a free end of a piston rod to the carriage 5. Hydraulic operation of the cylinder 16 thus causes axial displacement of the carriage 5 along the guide means in the direction of the arrow c.

The drive of the apparatus further includes control and regulating means, preferably in the form of electromagnetically operated hydraulic valves 17, 18, switches and chokes which, in connection with an electronic control unit, also allow computer-regulated speed control as well as acceleration control of the cylinders. A hydraulic pulse generator with a high-pressure hydraulic pump and a hydraulic reservoir is provided as the hydraulic energy source. The reservoirs are preferably constructed as gas-pressure reservoirs. It goes without saying that, depending on the power requirements, several of the abovementioned components may also be provided in each case without departing from the invention.

The test procedure is generally as follows. First the pump of the pulse generator before the actual test generates a large enough pressure pad. The latter is accumulated in the reservoir. Then there is hydraulic separation of the pump from the remaining equipment by means of a hydraulic separating valve. The pressure control and regulating valves of the apparatus are at this time in a shut-off position and not opened until activation by means of an activation device has taken place.

This can be for example an acceleration-sensitive airbag control device (if the apparatus is mounted on a carriage 19). After activation at the exact time, the two hydraulic cylinders are suddenly subjected to the accumulated pressure, which leads to the desired displacement. Naturally it is not absolutely necessary for the two cylinders 11, 16 to be acted upon simultaneously. Instead, owing to the electronic control the apparatus allows separate control of each of the two cylinders 11, 16 and hence many movement cycles. As a result the respective body deformation behaviour can be simulated optimally.

End-position damping minimizes the energy impact which occurs on moving into an end position, and therefore contributes to increased fatigue strength. As a result, a particularly light and delicate construction is made possible. End-position damping can be converted in different ways. On the one hand it is possible to let the mechanical brake means be applied to the piston rods or to the piston faces before an end position is reached. This possibility is satisfying on account of the relatively low expenditure on construction. According to another solution, end-position damping is converted by hydraulic means in such a way that a flow process is choked at the end of a movement, resulting in a corresponding deceleration. Such solutions allow easier modifications and adaptations to different deceleration requirements.

In any case it is an advantage if the carriage 5 and its attachments, such as for example the cylinders 11, 16 or their parts, are made of lightweight materials. This reduces the moving mass and the corresponding inertia forces.

An embodiment of the invention is characterized in that the apparatus 1 is arranged in a vehicle cell (body) or on a carriage 19 simulating the vehicle cell. This variant is connected with the advantage that the interaction of all restraint systems, such as for example belt restraint systems and airbag systems, can be examined within the framework of a crash with leg space intrusion. In other words, mounting the apparatus 1 on the carriage 19 (which forms the vehicle cell) allows not only the simulation of a collision with the corresponding (negative) acceleration values, but also the simulation of leg space intrusions as a result of the accident. This is achieved by the fact that the acceleration-sensitive activation device is activated as a result of the sudden speeding up of deceleration, and triggers the cylinder movements concerning carriage 5 and foot plate 8 for simulation of the leg space intrusion. It goes without saying that the length of time between the cylinder movement and the collision is adjusted so as to correspond to the real time between accident and leg space intrusion.

Finally many modifications and embodiments of the invention are conceivable without departing from its basic concept.

What is claimed is:

1. Apparatus for simulating a vehicle collision, characterized by a carrier with linear guide means for a carriage, which carriage is arranged so as to be movable relatively as well as translationally to the carrier, and wherein a foot plate is linked to the carriage so as to be rotationally movable about an axis of rotation.

2. Apparatus for simulating a vehicle collision according to claim 1, characterized in that associated with the foot plate and carriage are pyrotechnic drive means for a relative movement and/or rotation of carriage and/or foot plate.

3. Apparatus for simulating a vehicle collision according to claim 1, characterized in that hydraulic drive means are provided for a relative movement and/or rotation of carriage and/or foot plate.

4. Apparatus for simulating a vehicle collision according to claim 3, characterized in that the drive means in each case include at l east one hydraulic cylinder for moving the foot plate and in each case at least one hydraulic cylinder for moving the carriage.

5. Apparatus according to patent claim 3, characterized in that the drive means comprise a hydraulic pulse generator with at least one high-pressure hydraulic pump and a hydraulic reservoir.

6. Apparatus for simulating a vehicle collision according to claim 4, characterized in that each cylinder is assigned hydraulic control means, in particular hydraulic control valves, for pulsed controlled displacement of foot plate and carriage.

7. Apparatus for simulating a vehicle collision according to one claim 6, characterized in that an activation device is provided for the hydraulic control means, and in that the control means are not cleared until after an electrical signal of the activation device.

8. Apparatus for simulating a vehicle collision according to claim 3, characterized in that the hydraulic drive means enable a pressureless bypass position of the cylinders for manual cylinder positioning.

9. Apparatus for simulating a vehicle collision according to claim 4, characterized in that one of the hydraulic cylinder for driving the foot plate and the hydraulic cylinder for driving the carriage exhibit end-position damping for reducing the acceleration and/or deceleration forces.

10. Apparatus for simulating a vehicle collision according to claim 4, characterized in that at least one of the hydraulic cylinders is provided with means for varying the stroke length. cm 11. Apparatus for simulating a vehicle collision according to claim 1, characterized in that the carrier is fixed to the carriage simulating a vehicle cell.
